(19) United States
(12) Patent Application Publication
(10) Pub. No.: US 2006/0083172 A1
(43) Pub. Date: Apr. 20, 2006

(54) System and method for evaluating the performance of an automotive switch fabric network

(76) Inventors: Patrick D. Jordan, Austin, TX (US); Alexey V. Bakhtin, St. Petersburg (RU); Hai Dong, Austin, TX (US); Hugh W. Johnson, Cedar Park, TX (US); Prakash U. Kartha, Round Rock, TX (US); Samuel M. Levenson, Arlington Heights, IL (US); Olga I. Tykuchinskaya, St. Petersburg (RU)

Correspondence Address: DONNA & WILLIAM CONN, 20306 SEABROOK DRIVE, MONTGOMERY VILLAGE, MD, 20886, US

(21) Appl. No.: 11/015,529

(22) Filed: Dec. 17, 2004

Related U.S. Application Data
(60) Provisional application No. 60/618,674, filed on Oct. 14, 2004.

(51) Int. Cl. H04L 1/00

(52) U.S. Cl. 370/241

(57) ABSTRACT

A system and method for evaluating the performance of an automotive switch fabric network using a diagnostic interface. A diagnostic device and interface is connected to an automotive switch fabric network, comprising of a plurality of communication nodes, through one of the nodes in the switch fabric network. The diagnostic device and interface configures the switch fabric network to operate in a test mode. The diagnostic device and interface will issue a first command to one node to start traffic across a test node at a predetermined traffic rate and a second command to another node to generate a test message that passes through the test node. The test node contains message processing logic that will process the messages as they pass through the test node. A plurality of timestamps is generated in the message processing logic of the test node to monitor the progression of the messages through the processing logic. The test node includes a diagnostic interface agent that collects the timestamp data and reports the data back to the diagnostic interface and device.

The present application claims priority from provisional application, Ser. No. 60/618674, entitled “System and Method for Evaluating the Performance of an Automotive Switch Fabric Network,” filed Oct. 14, 2004, which is commonly owned and incorporated herein by reference in its entirety.

### FIELD OF THE INVENTION

This invention in general relates to in-vehicle communication networks and particularly to a system and method for evaluating the performance of an automotive switch fabric network using a diagnostic interface.

### BACKGROUND OF THE INVENTION

The commonly assigned United States patent application entitled “Vehicle Active Network,” Ser. No. 09/945,581, Publication Number US 2003043793, filed Aug. 31, 2001, the disclosure of which is hereby expressly incorporated herein by reference, introduces the concept of an active network that includes a switch fabric. The switch fabric is a web of interconnected switching devices or nodes. Control devices, sensors, actuators and the like are coupled to the switch fabric, and the switch fabric facilitates communication between these coupled devices.

The coupled devices may be indicator lights, vehicle control systems, vehicle safety systems, and comfort and convenience systems. A command to actuate a device or devices may be generated by a control element coupled to the switch fabric and is communicated to the device or devices via the switch fabric nodes.

In the context of vehicular switch fabric networks, a challenge is presented in terms of how to evaluate the performance of different configurations of, and different communication paths across, the switch fabric network and particular nodes. The performance of an automotive switch fabric can be measured different ways but some important considerations include measuring latency and jitter. A need exists for the ability to evaluate the performance of various network configurations and communication paths. Knowledge of the performance of various network configurations and communication paths will allow a designer or manufacturer the ability to choose the right configurations and paths to meet real time requirements.

It is, therefore, desirable to provide a system and method to overcome or minimize most, if not all, of the preceding problems especially in the area of evaluating the performance of nodes in an automotive switch fabric network.

### BRIEF DESCRIPTION OF THE DRAWINGS

FIG. 1 is a block diagram illustrating an embodiment of a vehicle switch fabric network;

FIG. 2 is a diagram illustrating a portion of the switch fabric network connected to a plurality of interfaces and devices;

FIG. 3 is a diagram illustrating one embodiment of a node in the switch fabric network;

FIGS. 4a, 4b are diagrams illustrating one embodiment of software components that may reside in a gateway node and other remote nodes in the switch fabric network;

FIG. 5 is a diagram illustrating a diagnostic device and diagnostic interface connected to a switch fabric network for evaluating the performance of the network; and

FIG. 6 is a flow diagram illustrating one embodiment of the message processing logic for a node under evaluation.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is a system and method for evaluating the performance of an automotive switch fabric network using a diagnostic interface. In sum, a diagnostic device and interface is connected to an automotive switch fabric network, comprising of a plurality of communication nodes, through a gateway node. The diagnostic device and interface will configure the switch fabric network to operate in a test mode. In one embodiment of the test mode, the diagnostic interface will issue a first command to one node to start traffic across a test node at a predetermined traffic rate and a second command to another node to generate a test message that passes through the test node. The test node contains message processing logic that will process the messages as they pass through the test node. The rate and frequency of the message may be adjusted by a user. A set of timestamps is generated in the message processing logic of the test node to monitor the progression of the messages through the processing logic. The test node includes a diagnostic interface agent that collects the timestamp data and reports the data back to the diagnostic interface and device.

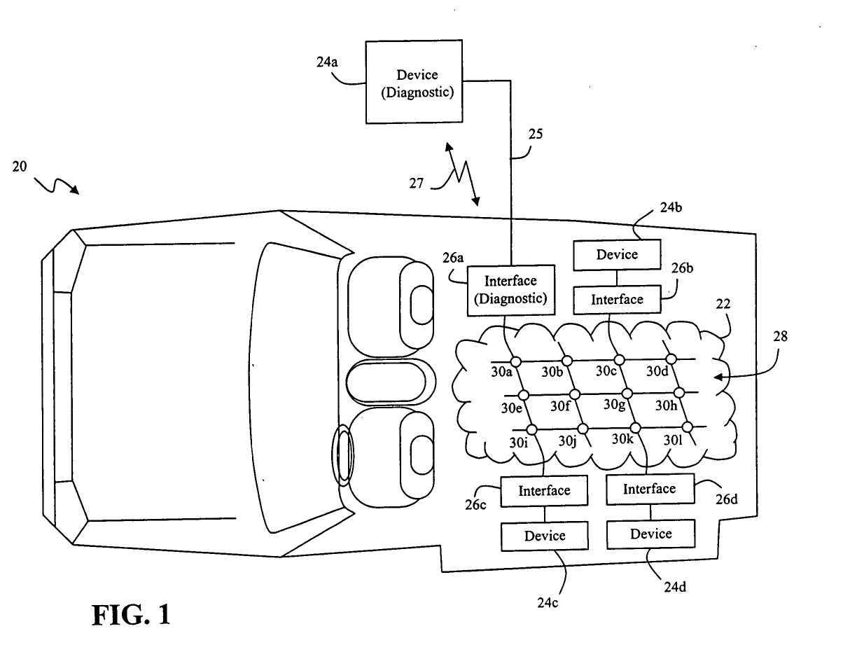

Now, turning to the drawings, FIG. 1 illustrates the function and operation of one embodiment of a switch fabric network in a vehicle 20. In this embodiment, the vehicle 20 includes a network 22 that interconnects various vehicle devices 24a-d through respective network interfaces 26a-d. The vehicle devices 24a-d may be sensors, actuators, and processors used in connection with various vehicle functional systems and sub-systems, such as, but not limited to, diagnostic, control-by-wire applications for throttle, braking and steering control, adaptive suspension, power accessory control, communications, entertainment, and the like. The devices 24a-d may be external or internal to the vehicle. The one embodiment, that includes a system for measuring the performance of the network 22, one of the devices is an external diagnostic device 24a.

The network interfaces 26a-d are any suitable interface for coupling the particular vehicle device 24a-d to the network 22, and may be wire, optical, wireless or combinations thereof. The vehicle device 24a-d is particularly adapted to provide one or more functions associated with the vehicle 20. The vehicle devices 24a-d may be data producing, such as a sensor, data consuming, such as an actuator, or processing, which both produces and consumes data. In one embodiment, the external device 24a is a processing diagnostic device that permits a user to exchange data with the network of the vehicle, as will be explained further below. Data produced by or provided to a vehicle device, and carried by the network 22, is independent of the function of the vehicle device itself.

The connection between the devices 24a-d and the respective interfaces 26a-d may be a wired or wireless connection. FIG. 1 illustrates both types of connections between the diagnostic device 24a and its interface 26a, a wired connection 25 and a wireless connection 27. In the wireless connection, the device 24a and the interface 26a include wireless communication transceivers permitting the units to communicate with each other via an optical or radio frequency transmission. Additionally, the interface 26a may be a single device or incorporated as a single assembly as part of a network gateway node 30a. Irregardless of the type of connection or type of assembly, the interface 26a to the diagnostic device 24a should arbitrate the linking of the device 24a to the network 22 through an authentication, security and encryption process.

The network 22 may include a switch fabric 28 defining a plurality of communication paths between the vehicle devices 24a-d. The communication paths permit multiple simultaneous peer-to-peer, one-to-many, many-to-many, etc. communications between the vehicle devices 24a-d. During operation of the vehicle 20, data exchanged, for example, between devices 24b and 24d may utilize any available path or paths between the vehicle devices 24b, 24d. In operation, a single path through the switch fabric 28 may carry all of a single data communication between one vehicle device 24b and another vehicle device 24d, or several communication paths may carry portions of the data communication. Subsequent communications may use the same path or other paths as dictated by the state of the network 22 or its performance. This provides reliability and speed advantages over bus architectures that provide single communication paths between devices, and hence are subject to failure with failure of the single path. Moreover, communications between other of the devices 24a, 24c may occur simultaneously using the communication paths within the switch fabric 28.

The network 22 may comply with transmission control protocol/Internet (TCP/IP), asynchronous transfer mode (ATM), Infiniband, RapidIO, or other packet data protocols. As such, the network 22 utilizes data packets, having fixed or variable length, defined by the applicable protocol. For example, if the network 22 uses asynchronous transfer mode (ATM) communication protocol, ATM standard data cells are used.

The internal vehicle devices 24b-d need not be discrete devices. Instead, the devices may be systems or subsystems of the vehicle and may include one or more legacy communication media, i.e., legacy bus architectures such as the Controller Area Network (CAN) protocol, the SAE J1850 Communication Standard, the Local Interconnect Network (LIN) protocol, the FLEXRAY Communications System Standard, the Media Oriented Systems Transport or MOST Protocol, or similar bus structures. In such embodiments, the respective interface 26b-d may be configured as a proxy or gateway to permit communication between the network 22 and the legacy device.

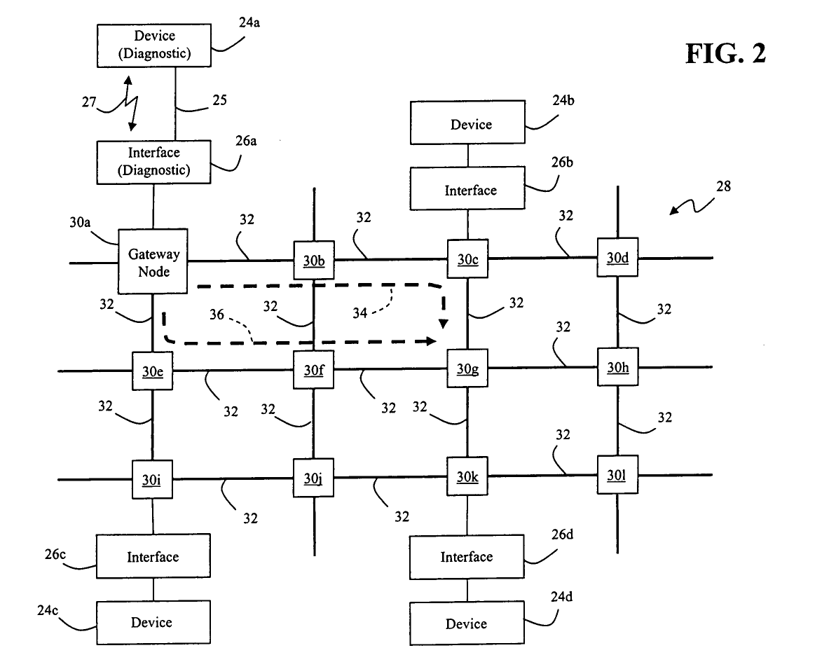

Referring to FIG. 2, an active network 22 in accordance with one embodiment of the present invention includes a switch fabric 28 of nodes 30a-1 that communicatively couples a plurality of devices 24a-d via respective interfaces 26a-d. Connection media 32 interconnects the nodes 30a-1. The connection media 32 may be bounded media, such as wire or optical fiber, unbounded media, such as free optical or radio frequency, or combinations thereof. In addition, the term node is used broadly in connection with the definition of the switch fabric 28 to include any number of intelligent structures for communicating data packets within the network 22 without an arbiter or other network controller and may include: switches, intelligent switches, routers, bridges, gateways and the like. For instance, in the embodiment shown in FIG. 2, the nodes include a gateway node 30a that connects the diagnostic interface 26a (and the diagnostic device 24a) to the switch fabric 28. Data is carried through the network 22 in data packet form guided by the nodes 30a-1.

The cooperation of the nodes 30a-1 and the connection media 32 define a plurality of communication paths between the devices 24a-d that are communicatively coupled to the network 22. For example, a route 34 defines a communication path from the gateway node 30a to a target node 30g. If there is a disruption along the route 34 inhibiting communication of the data packets from the gateway node 30a to the target node 30g, for example, if one or more nodes are at capacity or have become disabled or there is a disruption in the connection media joining the nodes along route 34, a new route, illustrated as route 36, can be used. The route 36 may be dynamically generated or previously defined as a possible communication path, to ensure the communication between the gateway node 30a and the target node 30g.

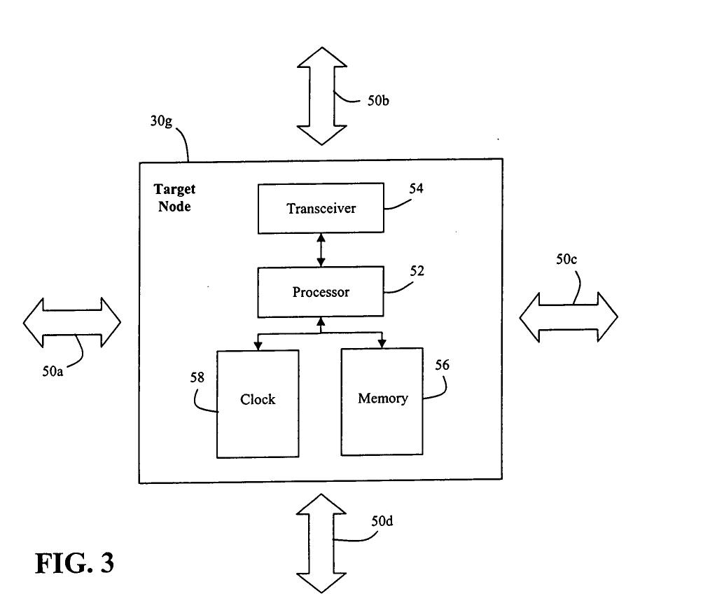

To illustrate the functionality and the adaptability of the nodes 30a-1, FIG. 3 shows one embodiment of the nodes 30a-1 having a plurality of input/output ports 50a-d although separate input and output ports could also be used. Various configurations of the nodes 30a-1 having more or fewer ports may be used in the network 22 depending on the application. Each node 30a-1 may include a processor 52, at least one transceiver 54, a memory 56, and a clock 58. The processor 52 includes a suitable control program for effecting the operation of the nodes for coupling inputs to outputs in order to transmit data packets within the switch fabric 28. The transceiver 54 may be a wireless transceiver or a wired transceiver depending on the type of communication media 32 that interconnects the nodes 30a-30l in the switch fabric 28. The memory 56 provides storage for the control programs for operating the nodes as well as, for purposes of the present invention, software components and modules to communicate with the diagnostic device 24a to aid in measuring the performance of the switch fabric 28. The clock 58 may be used, for purposes of the present invention, to record timestamps during the passage of a message through the node's message processing logic. The clock 58 may be subject to a common time base with other nodes in the switch fabric 28 or may be subject to synchronization steps as described in the patent applications “System and Method for Time Synchronizing Nodes in an Automotive Network Using Input Capture,” Ser. No. ______, and “System and Method for Time Synchronizing Nodes in An Automotive Network,” Ser. No. ______, both are commonly owned and filed concurrently herewith, the disclosures of which are hereby expressly incorporated herein by reference.

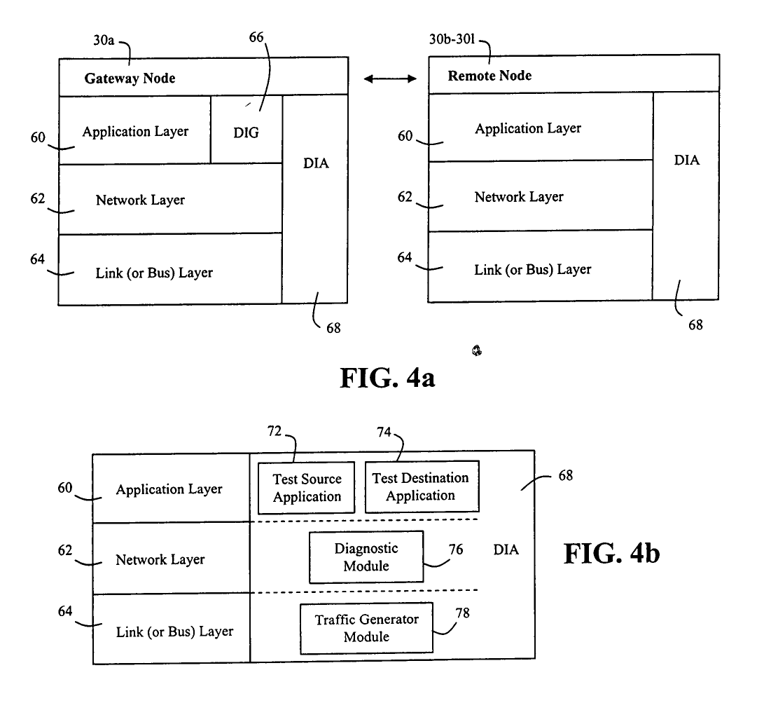

There is a need to measure the performance of different configurations of, and different communication paths across, the switch fabric 28 and particular nodes 30a-1. Accordingly, in one embodiment, the system is adapted to allow the diagnostic device 24a and interface 26a to operate the switch fabric 28 in a test mode by sending commands to and receiving data from various nodes. To aid in measuring the performance of the switch fabric 28, FIG. 4 illustrates the various software components that may reside in the gateway node 30a and the other remote nodes 30b-1 in the switch fabric 28.

In one embodiment, the gateway node 30a and the remote nodes 30b-1 include software components for an application layer 60, a network layer 62, and a link (or bus) layer 64. For the application layer 60, the gateway node 30a may further include a diagnostic interface gateway 66 application that allows the gateway node 30a to communicate with the diagnostic device 24a and diagnostic interface 26a. The gateway node 30a and the remote nodes 30b-1 further include a diagnostic interface agent 68 that spans across the application layer 60, the network layer 62, and the link (or bus) layer 64. As explained below, the diagnostic interface agent 68 may be configured to collect timestamp data and report the data back to the diagnostic interface and device.

In one embodiment, the diagnostic interface agent 68 includes a test source application 72 and a test destination application 74 are part of the application layer 60. When the test source application 72 is enabled in a node, the node will then be capable of sending a test message to another node having the test destination application 74 enabled. The diagnostic interface agent 68 may also include a traffic generator module 78 in the link layer 64. When the traffic generator component 78 is enabled in a node, the node will then start to send traffic messages that may be based on a rate and frequency by the system manager 40. The diagnostic interface agent 68 may further include a diagnostic module 76 that enables a node to collect data based on test messages and traffic messages being transmitted through the node. The transmission of test and traffic messages and the gathering of data is explained in further detail below.

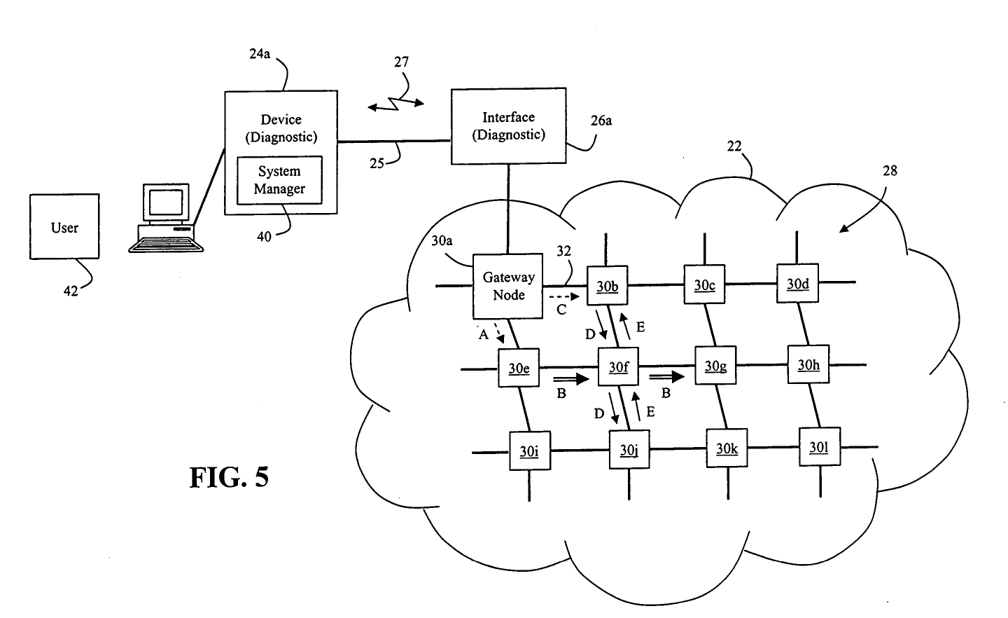

The embodiment and topology shown in FIG. 5 advantageously permits the ability to measure the performance of the switch fabric 28 using the diagnostic device 24a and diagnostic interface 26a. FIG. 5 shows a user 42 that can interact with a diagnostic device 24a. The diagnostic device 24a contains a software manager 40 that includes instructions for initiating and operating the switch fabric 28 in a test mode. The diagnostic device 24a is connected via a wired link 25 or a wireless link 27 to diagnostic interface 26a. The diagnostic interface 26a couples the diagnostic device 24a to the vehicle network 22 (and the switch fabric 28) through one of the nodes 30a-1, for example the gateway node 30a. In one embodiment, the diagnostic interface 26 is separate from the nodes 30a-1 in the switch fabric network 28. However, in other embodiment, the diagnostic interface 26a and its functions may be incorporated directly into one of the nodes 30a-1.

FIG. 5 illustrates one embodiment of a method for evaluating the performance of communication paths through the switch fabric 28. Although specific measurements are implementation specific, and one of ordinary skill in the art having the benefit of this disclosure will realize that other test modes may be used within the framework of the present invention, FIG. 5 illustrates an exemplary test mode for evaluating the performance of the nodes of the switch fabric 28. The switch fabric 28 include a plurality of communication nodes 30a-30l that are joined together by communication links 32 for the transmission of data there between. In this embodiment, the plurality of nodes 30a-30l include a gateway node 30a, a test node 30f, a first neighboring test node 30e and a second neighboring test node 30b. The system manager 40 in the diagnostic device 24a will begin by configuring the switch fabric 28 to a test mode. This may include disabling applications relating to the regular operation of the switch fabric 28. The system manager 40 in the diagnostic device 24a may then send a first control message to the gateway node 30a through the diagnostic interface 26a. The gateway node 30a will receive the first control message and may route the first control message to the first neighboring test node 30e (arrow A). The first control message may contain a command for the first neighboring test node 30e to generate traffic messages through the test node 30f (arrows B). The rate and frequency of the traffic messages may be adjusted by a user at the diagnostic device 24a and inserted into the first control message.

The system manger 40 in the diagnostic device 24 may then send a second control message to the gateway node 30a through the diagnostic interface 26a. The gateway node 30a will receive the second control message and may route the second control message to the second neighboring test node 30b (arrow C). The second control message may contain a command for the second neighboring test node 30b to generate a test message through the test node 30f (arrows D). In one embodiment, the test message may be send through the test node 30f to another neighboring node 30j that causes the node 30j to respond with a reply test message back through the test node 30f (arrows E).

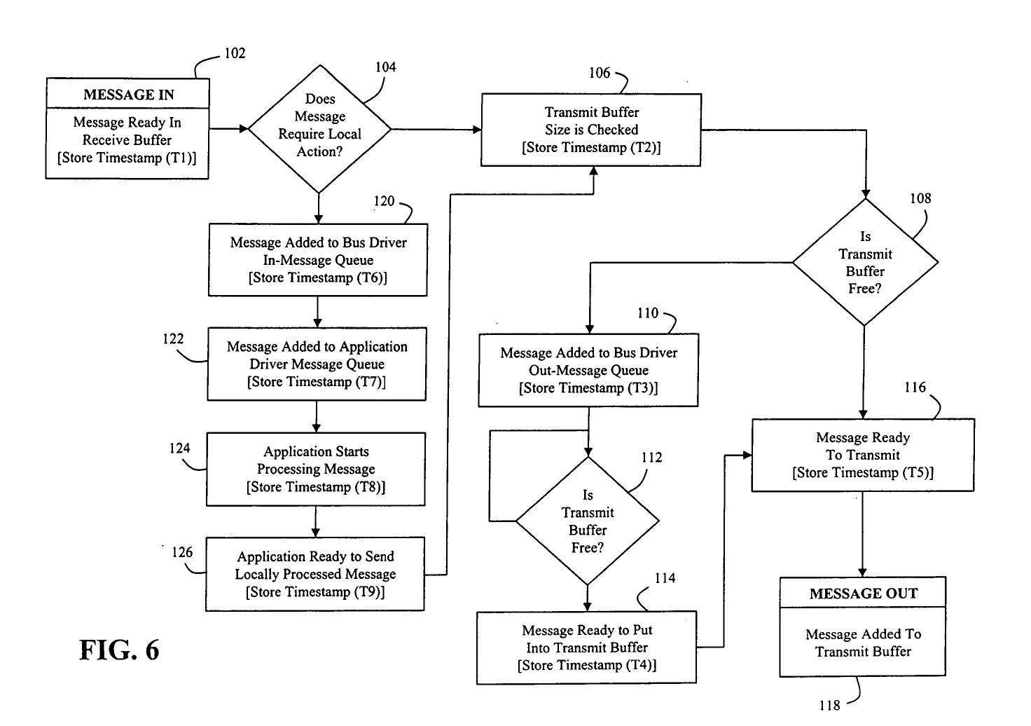

In one embodiment of the present invention, as the first neighboring test node 30e is transmitting traffic messages through the test node 30f and the second neighboring test node 30b is transmitting the test message through the test node 30f, the test node 30f is configured to generate and store a plurality of timestamps as the messages pass through the test node's processing logic. FIG. 6 illustrates one example of a flow for establishing timestamps in the message processing logic and for measuring the performance of the switch fabric 28.

In this example, the test node 30f will receive a message, such as a traffic message or a test message, in the node's receive buffer. In process block 102, the test node 30f may be configured to store a timestamp (T1) when a new message is ready to be processed out of the node's receive buffer. At decision block 104, the processing logic of the test node 30f may then determine whether the message requires any local action. For instance, if the message is simply a traffic message that was received from the first neighboring node 30e (and intended for another neighboring node 30g), the test node 30f may then continue to process block 106 where the size of the transmit buffer is checked. In one embodiment, as the size of the transmit buffer is checked, another timestamp (T2) is stored that is associated with verifying the availability of the transmit buffer. At decision block 108, if the transmit buffer is not free, then the process may continue to process block 110 where the message is added to a bus driver out-message queue and another timestamp (T3) is stored in memory. At this point, a transmit interrupt handler may be enabled and a determination may be made when the transmit buffer is free (block 112). At process block 114, a timestamp (T4) may be recorded that is associated with the time that the message is ready to be put into the transmit buffer.

As shown in process block 116, the test node 30f may be configured to store another timestamp (T5) when the message is ready to be transmitted out of the test node 30f. In process block 118, the outgoing message is then added to the transmit buffer of the test node 30f.

Referring back to decision block 104, if the message requires local action, the process may continue to process block 120 where the incoming message is added to a bus driver in-message queue and a timestamp (T6) is stored. Thereafter, the process may further include adding the message to an application driver message queue (block 122) and storing another timestamp (T7). As shown in block 124, the application associated with the processing the test message may then start and include the storage of a further timestamp (T8). After the application has processed the message, and the test node 30f is ready to send a locally processed message out of the test node 30f, the test node may then store another timestamp (T9) (block 126). The process may then continue to blocks 106-118 where the transmit buffer size is checked and, eventually, the locally processed message is added to the transmit buffer.

The test node 30f may then be configured to calculate performance parameters of the node (such as latency). The test node 30f may further be configured to transmit any calculated performance parameters, or the raw data including the stored timestamps, to the diagnostic device 24a for further analysis or presentation to the user 42.

There are different ways that the test mode may stop during the test period. First, the test mode may be stopped by a command from the diagnostic device. Second, the test mode may be stopped when a specified condition is satisfied. One condition may include a threshold number of test messages or traffic messages sent by the test system. Another condition may be duration of time. These conditions may be configured by the user 42 and specified in the control messages generated by the system manager 40.

What has been described is a system and method for evaluating the performance in an automotive switch fabric network using a diagnostic interface. The processing flow and timestamps shown in FIG. 5 and 6 are implementation specific. One of ordinary skill in the art with the benefit of this disclosure will realize that test modes may be applied to different configurations and the number of timestamps may increase or decrease depending on the type of measurements that a designer wishes to evaluate. Accordingly, the above description of the present invention is intended to be exemplary only and is not intended to limit the scope of any patent issuing from this application. The present invention is intended to be limited only by the scope and spirit of the following claims.

What is claimed is:

1. A system for evaluating the performance of a vehicle network, the vehicle network including a plurality of nodes joined by communication links for the transmission of data there between, the system comprising:
a diagnostic device for configuring the vehicle network in a test mode;
a node in the vehicle network connected to the diagnostic device for receiving a control message from the diagnostic device;
a test node having message processing logic, the message processing logic including the capability of storing a plurality of timestamps that monitor the progressing of a test message through the test node during the test mode;
wherein the control message received from the diagnostic device includes a command to generate a test message through the test node.

2. The system in claim 1, wherein the node further receives another control message from the diagnostic device that includes a command to generate a plurality of traffic message through the test node during the test mode.

3. The system in claim 2, wherein the diagnostic device is configured to allow a user to adjust a rate at which the plurality of traffic messages pass through the test node.

4. The system in claim 1, wherein the node connected to the diagnostic device is a gateway node, the test node configured to report the plurality of timestamps to the diagnostic device through the gateway node.

5. The system in claim 4, wherein the plurality of timestamps includes at least one timestamp associated with the test message in a receive buffer of the test node.

6. The system in claim 4, wherein the plurality of timestamps includes at least one timestamp associated with the test message being processed by an application in the test node.

7. The system in claim 4, wherein the plurality of timestamps includes at least one timestamp associated with the test message in a transmit buffer of the test node.

8. A method for evaluating the performance of a vehicle network, the vehicle network including a plurality of nodes joined by communication links for the transmission of data there between, the plurality of nodes including a gateway node, a test node, a first neighboring test node and a second neighboring test node, the method comprising the steps of:
configuring the vehicle network in a test mode;
receiving, at the gateway node, a first control message and routing the first control message to the first neighboring test node, the first control message containing a command to generate traffic messages through the test node;
receiving, at the gateway node, a second control message and routing the second control message to the second neighboring test node, the second control message containing a command to send a test message through the test node; and
generating a plurality of timestamps as the test message is sent through the test node.

9. The method in claim 8, wherein the first control message and the second control message is received by the gateway node from a diagnostic device.

10. The method in claim 9 further comprising the step of reporting the plurality of generated timestamps to the diagnostic device.

11. The method in claim 8, wherein the first control message further includes a rate for generating traffic messages through the test node.

12. The method in claim 8, wherein the plurality of timestamps includes at least one timestamp associated with the test message in a receive buffer of the test node.

13. The method in claim 8, wherein the plurality of timestamps includes at least one timestamp associated with the test message being processed by an application in the test node.

14. The method in claim 8, wherein the plurality of timestamps includes at least one timestamp associated with the test message in a transmit buffer of the test node.

15. A method for evaluating the performance of a vehicle network, the vehicle network including a plurality of nodes joined by communication links for the transmission of data there between, the plurality of nodes including a gateway node and a test node, the method comprising the steps of:
configuring the vehicle network in a test mode;
sending a first control message to the gateway node, the first control message containing a command to generate traffic messages through the test node;
sending a second control message to the gateway node, the second control message containing a command to send a test message through the test node; and
generating a plurality of timestamps as the test message is sent through the test node.

16. The method in claim 15, wherein the first control message and the second control message is sent to the gateway node by a diagnostic device.

17. The method in claim 16 further comprising the step of reporting the plurality of generated timestamps to the diagnostic device.

18. The method in claim 15, wherein the first control message further includes a rate for generating traffic messages through the test node.

19. The method in claim 15, wherein the plurality of timestamps includes at least one timestamp associated with the test message in a receive buffer of the test node.

20. The method in claim 15, wherein the plurality of timestamps includes at least one timestamp associated with the test message being processed by an application in the test node.

21. The method in claim 15, wherein the plurality of timestamps includes at least one timestamp associated with the test message in a transmit buffer of the test node.
